(19) United States
(12) Patent Application Publication
(10) Pub. No.: US 2015/0225169 A1
(43) Pub. Date: Aug. 13, 2015

(54) Capsule Assemblies With Data Storage and Communication Means

(71) Applicant: Nestec S.A., Vevey (CH)

(72) Inventor: Christian Jarisch, Lutry (CH)

(73) Assignee: Nestec S.A., Vevey (CH)

(21) Appl. No.: 14/422,894

(22) PCT Filed: Aug. 8, 2013
(86) PCT No.: PCT/EP2013/066609

§ 371 Date: Feb. 20, 2015

(30) Foreign Application Priority Data
Aug. 22, 2012 (EP) 12181292.9
Aug. 22, 2012 (EP) 12181428.9

(51) Int. Cl. B65D 85/804; G06K 19/07; G06K 7/00; A47J 31/44

(52) U.S. Cl. CPC B65D 85/8043; A47J 31/4492; G06K 19/0724; G06K 7/0008

(57) ABSTRACT

The invention pertains to the field of the beverage preparation machines, and more particularly to a capsule a capsule for containing a beverage ingredient, comprising a communication assembly, said communication assembly comprising an integrated circuit coupled with an antenna, the antenna having sensibly a ring shape and being mounted on a rim portion of the capsule, the communication assembly being adapted to transmit information related to the capsule to an external reader.

### CROSS REFERENCE TO RELATED APPLICATIONS/INCORPORATION BY REFERENCE STATEMENT

This application is a US national stage application filed under 35 USC §371 of International Application No. PCT/EP2013/066609, filed Aug. 8, 2013; which claims benefit of EP Application No. 12181292.9, filed Aug. 22, 2012, and EP Application No. 12181428.9, filed Aug. 22, 2012. The entire contents of the above-referenced applications are hereby expressly incorporated herein by reference.

### FIELD OF THE INVENTIVE CONCEPT(S)

The presently disclosed and/or claimed inventive concept(s) pertains to the field of capsules containing an ingredient for preparing a beverage, adapted to cooperate with beverage preparation machines having a brewing chamber that can be opened and closed for inserting the capsule into the chamber and/or removal of a used capsule therefrom. More particularly, the presently disclosed and/or claimed inventive concept(s) relates to a capsule with data storage and communication means, providing a convenient and adaptable solution to store and transfer information to external devices.

For the purpose of the present description, a “beverage” is meant to include any human-consumable liquid substance, such as coffee, tea, hot or cold chocolate, milk, soup, baby food or the like. A “capsule” is meant to include any pre-portioned beverage ingredient or combination of ingredients (hereafter called “ingredient”) within an enclosing packaging of any suitable material such as plastic, aluminium, a recyclable and/or bio-degradable material and combinations thereof, including a soft pod or a rigid cartridge containing the ingredient.

### TECHNICAL BACKGROUND

Certain beverage preparation machines use capsules containing an ingredient to be extracted or to be dissolved and/or ingredient that is stored and dosed automatically in the machine or else is added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing a beverage ingredient is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

It is known to associate a radio frequency (RF) identifier to the capsule for the purpose of recognizing the capsule which is inserted in the device such as by a reader. Such identification allows changing particular operations, in the beverage producing device, in response to the detection of the identifier. For instance, brewing operations can be modified accordingly for adapting them to the type of capsule detected. For instance, brewing parameters, such as water temperature, the beverage volume or others, can be changed.

WO02/28241 relates to an encoded coffee packet including a machine interpretable feature on the capsule, for instance, electromagnetically detectable, e.g., a magnetic data storage medium.

FR2912124 relates to a portioned package for preparation of a beverage comprising two flexible walls connected by their seam and comprising an RFID tag for contactless reading which is positioned in a reinforced peripheral portion at the seam of the package.

EP1890271A1 relates to a method of controlling the dispensing of an infusion product with a container for a product dose and an RFID tag associated to a respective number of containers.

The prior art solutions typically contemplate the association of a contactless identifier such as a radio-frequency tag with the beverage portioned package. The package generally forms the support for the tag and can be produced during manufacturing of the package.

Certain identifiers placed on the package can be deteriorated, removed or modified. Certain identifiers are particularly sensitive to pressure or bending and may be easily broken. In particular, the portion package is submitted to relatively high forces during mechanical and/or hydraulic closing of the beverage brewing unit around or onto the package. As a result, the identifier can be damaged and is no longer readable and the capsule is irremediably wasted.

### BRIEF DESCRIPTION OF THE DRAWINGS

The presently disclosed and/or claimed inventive concept(s) will now be described with reference to the schematic drawings, wherein:

FIG. 1 is a cross section of a capsule adapted to be used by a beverage machine to prepare a beverage;

FIGS. 2a and 2b are schema of an embodiment of a capsule according to the presently disclosed and/or claimed inventive concept(s);

FIG. 3 is a schema of another embodiment of a capsule according to the presently disclosed and/or claimed inventive concept(s);

FIG. 4 are schema of another embodiment of a capsule according to the presently disclosed and/or claimed inventive concept(s).

### DETAILED DESCRIPTION

An object of the presently disclosed and/or claimed inventive concept(s) is to embed storage and communication means, in a capsule assembly, compatible with food-safety requirements. Another object is to provide a reliable solution for receiving and transmitting information. Another object is to provide a solution less prone to damage or deterioration, in particular during handling of the capsule assembly. Another object is to provide a cost efficient solution, in particular in term of assembly and production costs. One or more of these objects are met by a machine according to the independent claim(s). The dependent claims further provide solutions to these objects and/or additional benefits.

More particularly, according to a first aspect, the presently disclosed and/or claimed inventive concept(s) relates to a capsule for containing a beverage ingredient, comprising a communication assembly, said communication assembly comprising an integrated circuit coupled with an antenna, the antenna having sensibly a ring shape and being mounted on a rim portion of the capsule, the communication assembly being adapted to transmit information related to the capsule to an external reader.

The capsule may be provided with a seal at its outer face, the communication assembly being disposed in the sealing member or between the sealing member and the outer face of the capsule.

For example, the integrated circuit may comprise a first contact pad and a second contact pad, the first and the second contact pads being disposed relatively to each other on opposite sides of the integrated circuit, the contact pads being used to couple the integrated circuit to the antenna.

In an embodiment, the contact pads are spaced apart of each other sensibly by 75 μm.

In an embodiment, the integrated circuit is disposed into a support comprising a layer of polymer and covered by an insulation layer.

In particular, the communication assembly is adapted to be capacitively coupled to an external reader, using a low frequency, an High Frequency or an Ultra High Frequency communication technology.

According to a second aspect, the presently disclosed and/or claimed inventive concept(s) relates to a capsule for containing a beverage ingredient, comprising a communication assembly, said communication assembly comprising an integrated circuit, the integrated circuit being disposed inside the capsule between a peripheral rim and a membrane, the integrated circuit being arranged so as to be couple to the peripheral rim of a capsule and to the membrane.

In an embodiment, the integrated circuit comprises a first contact pad and a second contact pad, the first and the second contact pads being disposed relatively to each other on opposite sides of the integrated circuit, the contact pads being used to couple the integrated circuit to the peripheral rim of a capsule and to the membrane. In particular, the capsule the contact pads may be spaced apart of each other sensibly by 75 μm.

In an embodiment, the integrated circuit is mounted on the inner surface of the capsule without using an inlay.

In particular, the communication assembly is adapted to be capacitively coupled to an external reader, using a low frequency (LF) communication technology.

According to the first aspect of the presently disclosed and/or claimed inventive concept(s), or according to the second aspect of the presently disclosed and/or claimed inventive concept(s), the communication assembly may comprise a RFID interface. The communication assembly may be adapted to provide information related to preferences of a user, said information comprising one or any combination of the following information: user's preferred volume of beverage to prepare with the capsule, user's preferred temperature of beverage to prepare with the capsule, user's preferred pressure used for preparing a beverage with the capsule, user's preferred recipe used for preparing a beverage with the capsule, user's preferred ingredients used for preparing a beverage with the capsule, user's preferred additional ingredients used for preparing a beverage with the capsule, user's preferred pre-wetting setup used for preparing a beverage with the capsule. The communication assembly may be adapted to provide information related to the capsule, said information comprising one or any combination of the following information: unique identifier, type of capsule, date of production, batch number, type of ingredient included in the capsule, identifier, serial number.

According to a third aspect, the presently disclosed and/or claimed inventive concept(s) relates to a beverage preparation machine having an ingredient processing module for preparing a beverage with at least one ingredient supplied with a capsule according to the first aspect or according to the second aspect, said machine comprising a reader having a communication interface configured, when coupled with the communication assembly of the capsule, to read the information stored in the communication assembly.

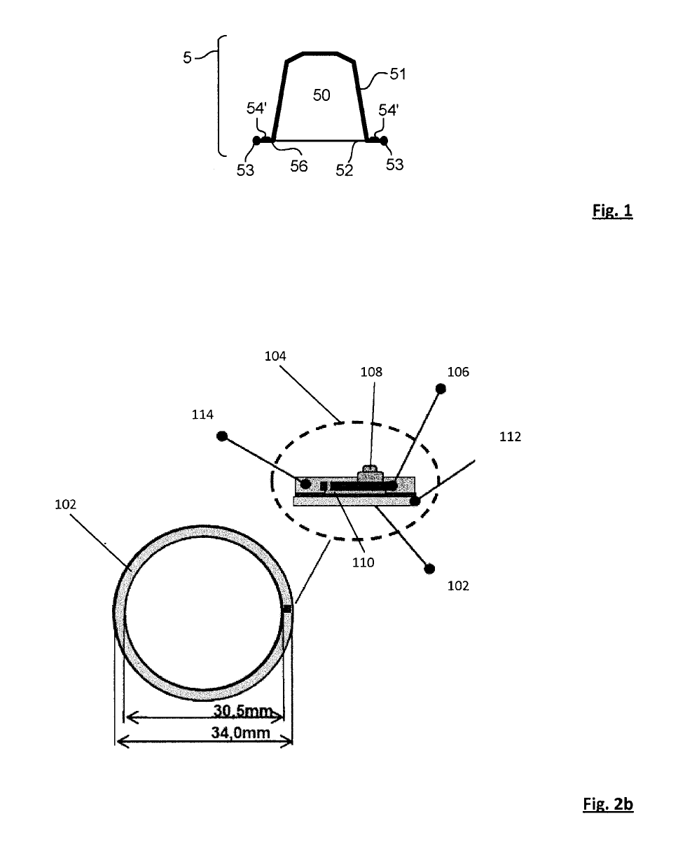

The brewing unit is represented in the opened position on FIG. 1. The brewing unit allows the preparation of a beverage from a capsule 5 containing at least one ingredient, e.g. ground coffee or tea or chocolate.

Referring to FIG. 1, there is shown therein a schema of a capsule 5 containing at least one ingredient, e.g. ground coffee or tea or chocolate. The capsule 5 has a generally cup-shaped body 51 and a covering membrane 52. Membrane is assembled to cup along a peripheral rim 54 of cup. The rim may be covered with a seal 54′, e.g. made of elastomeric material. Furthermore, the capsule in particular the rim and/or the membrane may bear a ring or toroid 53, e.g. for assisting manufacturing and/or handling of the capsule. Such capsule forms a packaging for containing an ingredient 50, e.g. ground coffee, of a beverage to be prepared with the beverage preparation machine. In an embodiment, the capsule forms a gastight packaging, e.g. made of aluminium or an aluminium-alloy. Alternatively, the capsule may be more or less pervious, e.g. perforated and/or made of organic, in particular plastic material, e.g. biodegradable material. The capsule's cup and/or the capsule's membrane may be made of a monolithic material, e.g. a metallic material or a conductive ceramic and/or conducive organic material, or may be made of a structure covered or containing a conductive material, e.g. a conductive coating or track, e.g. an aluminium, iron and/or copper coating or track. The capsule comprises a storage 56 provided with a memory. In particular, the memory may be accessed in a read mode for getting access to stored information. In some embodiment, the memory may also be accessed in a write mode for writing information within the memory. For example, the memory may be configured to store information provided by a user. The memory may also be configured to store identification and/or production information, for instance serial numbers, production date, batch identifier, custom parameters, allowing a reader having access to this information to identify a type for this capsule and/or verify expiration data and/or customize the processing of said capsule. The storage 56 comprises a capsule communication interface adapted to allow an external arrangement to access the memory, more particularly to read and/or optionally write its content.

In a specific embodiment of the storage, the communication interface allows wireless communications. Typically, the storage 56 may be a RFID assembly having at least a read mode in which a memory can be read by an external RFID reader.

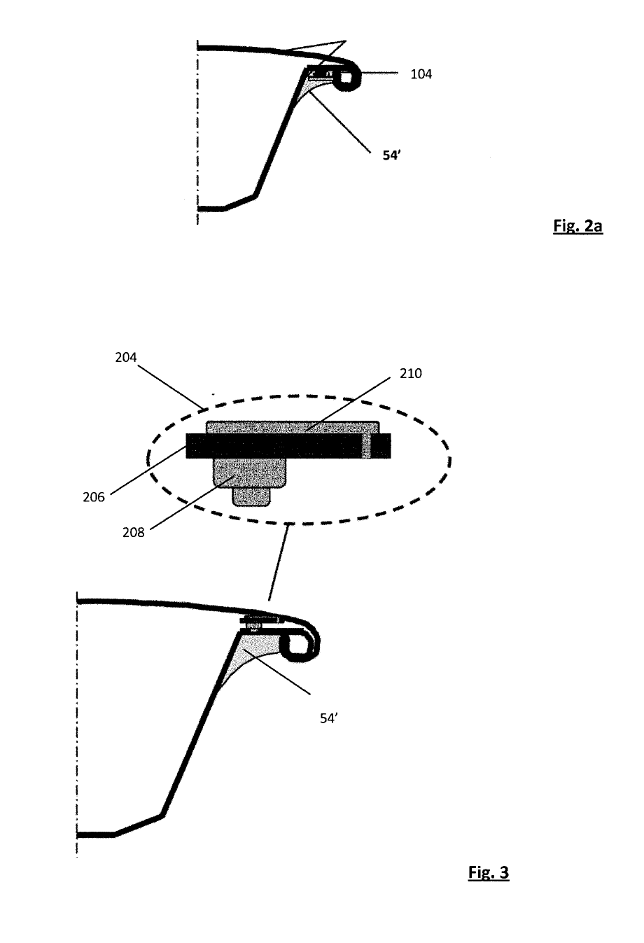

Referring to FIGS. 2a and 2b, there is shown therein an embodiment of a capsule embedding a RFID assembly 104. The RFID assembly 104 comprises a ring antenna 102 cooperating with an integrated circuit IC 106. The geometry of the ring antenna 102 is sensibly annular, and is adapted to be mounted on the bottom side of the rim of the capsule, i.e. on the opposite side of the rim which is in contact with the membrane as illustrated on FIG. 2a. The integrated circuit IC 106 comprises a first contact pad 108 and a second contact pad 110, the first and the second contact pads being disposed relatively to each other on opposite sides of the integrated circuit IC 106. In particular the contact pads are used to couple the integrated circuit IC 106 to the antenna 102. Typically, the contact pads are spaced apart of each other sensibly by 75 μm. The integrated circuit IC 106 is disposed into a support 112, typically a layer of polymer, for instance a layer of Polyethylene terephthalate PET, and covered by an insulation layer 114. The RFID assembly 104 is adapted to be mounted on the bottom side of the rim of the capsule, and be covered by the seal 54′. The RFID assembly 104 is adapted to be capacitively coupled to an RFID reader, in particular using an low frequency (LF) or an High Frequency (HF) RFID technology.

Since the RFID assembly 104 is placed inside the seal 54′, and covered by a silicon sealant for example, contact with coffee or water are avoided, increasing the reliability of the RFID assembly 104. Moreover, the RFID assembly 104 is better protected for external aggressions, for example, mechanical deformations and pressure. Also, functionality of the RFID assembly 104 may be tested as soon as the RFID assembly is mounted on the body of the capsule and before filling and sealing the capsule.

Referring to FIG. 3, there is shown therein another embodiment of a capsule embedding a RFID assembly 204. The RFID assembly 204 comprises an integrated circuit IC 206. The integrated circuit IC 206 comprises a first contact pad 208 and a second contact pad 210, the first and the second contact pads being disposed relatively to each other on opposite sides of the integrated circuit IC 206. Typically, the contact pads are spaced apart of each other sensibly by 75 μm. The integrated circuit IC 206 is disposed inside the capsule between the peripheral rim 54 of cup and the membrane 52 so as to couple the integrated circuit IC 206 the peripheral rim 54 and to the membrane 52. In this embodiment, the capsule body and the lid of the capsule are electrically isolated. The RFID assembly 204 is an inlayless solution, allowing great reduction of costs. The RFID assembly 204 is adapted to be capacitively coupled to an RFID reader, in particular using an low frequency (LF) RFID technology.

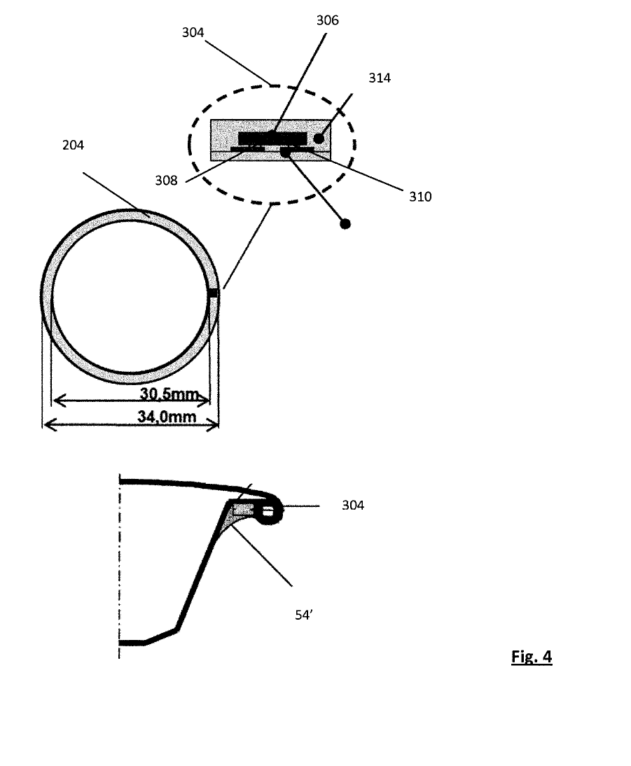

Referring to FIG. 4, there is shown therein an embodiment of a capsule embedding a RFID assembly 304. The RFID assembly 304 comprises a ring antenna 302 cooperating with an integrated circuit IC 306. The geometry of the ring antenna 302 is sensibly annular, and is adapted to be mounted on the bottom side of the rim of the capsule, i.e. on the opposite side of the rim which is in contact with the membrane as illustrated on FIG. 3a. The integrated circuit IC 306 comprises a first contact pad 308 and a second contact pad 310, the first and the second contact pads being disposed relatively to each on the same side of the integrated circuit IC 306. In particular the contact pads are used to couple the integrated circuit IC 306 to the antenna 302. Typically, the contact pads are made of Gold. The integrated circuit IC 106 is disposed into a support 312, typically a layer of Aluminium (with a thickness of sensibly 10 μm for example) and a layer of polymer, for instance a layer of Polyethylene terephthalate PET (with a thickness of sensibly 50 μm for example). The integrated circuit IC 306 is covered by a spacing element 314 having a thickness of sensibly 300 μm for example. The integrated circuit IC 306 may be attached with a direct chip attachment assembly technology to the structured ring antenna 302. The RFID assembly 304 is adapted to be mounted on the bottom side of the rim of the capsule, and be covered by the seal 54′. The RFID assembly 304 is adapted to be capacitively coupled to an RFID reader, in particular using an Ultra High Frequency (UHF) near field RFID technology.

Since the RFID assembly 304 is placed inside the seal 54′, and covered by a silicon sealant for example, contact with coffee or water are avoided, increasing the reliability of the RFID assembly 304. Moreover, the RFID assembly 304 is better protected for external aggressions, for example, mechanical deformations and pressure. Also, functionality of the RFID assembly 304 may be tested as soon as the RFID assembly is mounted on the body of the capsule and before filling and sealing the capsule.

1. A capsule for containing a beverage ingredient, characterized in that it comprises a communication assembly, said communication assembly comprising an integrated circuit coupled with an antenna, the antenna having sensibly a ring shape and being mounted on a rim portion of the capsule, the communication assembly being adapted to transmit information related to the capsule to an external reader.

2. The capsule according to claim 1, wherein the capsule is provided with a seal at its outer face, the communication assembly being disposed in the sealing member or between the sealing member and the outer face of the capsule.

3. The capsule according to claim 1, wherein the integrated circuit comprises a first contact pad and a second contact pad, the first and the second contact pads being disposed relatively to each other on opposite sides of the integrated circuit, the contact pads being used to couple the integrated circuit to the antenna.

4. The capsule according to claim 3, wherein the contact pads are spaced apart of each other sensibly by 75 μm.

5. The capsule according to claim 3, wherein the integrated circuit is disposed into a support comprising a layer of polymer and covered by an insulation layer.

6. The capsule according to claim 1, wherein the communication assembly is adapted to be capacitively coupled to an external reader, using a low frequency (LF), an High Frequency (HF), or an Ultra High Frequency (UHF) communication technology.

7. A capsule for containing a beverage ingredient, characterized in that it comprises a communication assembly, said communication assembly comprising an integrated circuit, the integrated circuit being disposed inside the capsule between a peripheral rim and a membrane, the integrated circuit being arranged so as to be couple to the peripheral rim of a capsule and to the membrane.

8. The capsule according to claim 7, wherein the integrated circuit comprises a first contact pad and a second contact pad, the first and the second contact pads being disposed relatively to each other on opposite sides of the integrated circuit, the contact pads being used to couple the integrated circuit to the peripheral rim of a capsule and to the membrane.

9. The capsule according to claim 8, wherein the contact pads are spaced apart of each other sensibly by 75 μm.

10. The capsule according to claim 7, wherein the integrated circuit is mounted on the inner surface of the capsule without using an inlay.

11. The capsule according to claim 7, wherein the communication assembly is adapted to be capacitively coupled to an external reader, using a low frequency (LF) communication technology.

12. The capsule according to claim 1, wherein the communication assembly comprises a RFID interface.

13. The capsule according to claim 1, wherein the communication assembly is adapted to provide information related to preferences of a user, said information comprising one or any combination of the following information: user's preferred volume of beverage to prepare with the capsule, user's preferred temperature of beverage to prepare with the capsule, user's preferred pressure used for preparing a beverage with the capsule, user's preferred recipe used for preparing a beverage with the capsule, user's preferred ingredients used for preparing a beverage with the capsule, user's preferred additional ingredients used for preparing a beverage with the capsule, user's preferred pre-wetting setup used for preparing a beverage with the capsule.

14. The capsule according to claim 1, wherein the communication assembly is adapted to provide information related to the capsule, said information comprising one or any combination of the following information: unique identifier, type of capsule, date of production, batch number, type of ingredient included in the capsule, identifier, serial number.

15. A beverage preparation machine having an ingredient processing module for preparing a beverage with at least one ingredient supplied with a capsule according to claim 1, said beverage preparation machine comprising a reader having a communication interface configured, when coupled with the communication assembly of the capsule, to read the information stored in the communication assembly.
